(19) United States
(12) Patent Application Publication
(10) Pub. No.: US 2005/0281231 A1
(43) Pub. Date: Dec. 22, 2005

(54) Apparatus and method for synchronization acquisition in a mobile communication system

(76) Inventors: Hyun-ll Kwon, Suwon-shi (KR); Joo-Kwong Kim, Yougn-shi (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/645,571

(22) Filed: Aug. 22, 2003

(30) Foreign Application Priority Data
Aug. 23, 2002 (KR) 2002-50003

(51) Int. Cl. H04B 7/216

(52) U.S. Cl. 370/335

(57) ABSTRACT

An apparatus and method for synchronization acquisition in a mobile communication system. A user equipment (UE) communicates with any one of a first Node B of a first system mode operating in a synchronous scheme and a second Node B of a second system mode operating in an asynchronous scheme in a mobile communication system. The apparatus and method include a controller for determining a system mode of a current Node B to which the UE belongs and generating a system mode select signal for selecting the determined system mode. Also provided is a code generator for generating a synchronization code used in the first system mode or the second system mode in response to the system mode select signal.

### PRIORITY

This application claims priority under 35 U.S.C. §119 to an application entitled “Apparatus and Method for Synchronization Acquisition in a Mobile Communication System” filed in the Korean Industrial Property Office on Aug. 23, 2002 and assigned Serial No. 2002-50003, the contents of which are incorporated herein by reference.

### BACKGROUND OF THE INVENTION

1. Field of the Invention

The present invention relates generally to a mobile communication system, and in particular, to an apparatus and method for adaptively acquiring synchronization both in an asynchronous mobile communication system and in a synchronous mobile communication system.

2. Description of the Related Art

With the development of a mobile communication system, a Code Division Multiple Access (CDMA) mobile communication system has evolved into an International Mobile Telecommunication-2000 (IMT-2000) system, which is the next generation mobile communication system. The IMT-2000 system refers to a wire/wireless integrated next generation communication service that provides a multimedia service, such as voice, high-speed data and picture services, and a global roaming service, via landline and wireless connections. The IMT-2000 system is standardized into a North American synchronous CDMA 2000 scheme and an European asynchronous wideband CDMA (W-CDMA) scheme. A Universal Mobile Telecommunication System (UMTS), which is a European next generation mobile communication system, uses the asynchronous W-CDMA scheme based on Global System for Mobile (GSM) communication. The UMTS, although it basically employs the CDMA scheme, is an asynchronous system that performs an asynchronous operation between Node Bs, using different synchronization codes. In contrast, the CDMA 2000 mobile communication system, which is a synchronous system based on an IS-95 mobile communication system, performs a synchronous operation between base stations, using codes determined by separating the same synchronization code by an offset value. A User Equipment (UE) operating in the synchronous and asynchronous systems necessitates a process of acquiring a synchronization code for a corresponding Node B. This is a process of searching for a synchronization code used in each Node B of the synchronous and asynchronous systems during the transmission of a downlink signal. The synchronization code is a short Pseudo Noise (PN) code for the synchronous system and a scrambling code for the asynchronous system. Consequently, synchronization acquisition of a Node B in the synchronous system is implemented by searching for an offset of a short PN code which is generated according to an absolute time. In the asynchronous system, synchronization acquisition is implemented by searching 512 scrambling codes.

In the asynchronous system, in order to search a current cell, or a current Node B to which a UE belongs, the UE searches respective cells, i.e., 512 cells constituting the asynchronous system. Thus it takes a long time to search the current cell by checking respective phases of codes constituting each cell specific code for each of the 512 cells. Since it is inefficient to apply a general cell search algorithm to respective cells constituting the asynchronous system, the UE uses a multistep cell search algorithm. For the multistep cell search algorithm, a plurality of cells belonging to the asynchronous system, for example, the 512 cells are classified into a prescribed number of groups, for example, 64 groups (Group #0 to Group #63). Different group specific codes are assigned to the classified 64 groups in order to identify cell groups each of which consists of 8 cells. A cell specific code is assigned to each of the 8 cells, so that the UE can search the current cell.

The multistep cell search algorithm consists of the following 3 cell search steps, i.e., a first-step cell search process, and a second-step cell search process, and a third-step cell search process. In the first-step cell search process, a UE receives a primary synchronization channel (P-SCH) signal from a Node B and performs synchronization by searching for a slot timing received at peak power. In the second-step cell search process, the UE receives information about the slot timing that was searched for in the first-step cell search process and detects frame synchronization and a current cell group through a secondary synchronization channel (S-SCH) transmitted from a Node B. In the third-step cell search process, the UE searches the current cell using a common pilot channel (CPICH) signal transmitted from the Node B based on information on the frame synchronization and the current cell group that was searched in the second-step cell search process.

While the synchronization acquisition process of a asynchronous system for performing an asynchronous cell operation has been described, the operation of a synchronous system in which synchronization between the cells is identified by an offset reference timing will now be described with reference to FIG. 1.

FIG. 1 is a block diagram illustrating a general synchronization acquisition apparatus for a CDMA mobile communication system. Referring to FIG. 1, if channel signals are received from a Node B, the received channel signals, that is, I and Q channel signals are input to a despreader 110. A PN code generator 105 internally generates PN codes upon receipt of the I and Q channel signals, and provides the identical PN codes that were used in the Node B during transmission of the channel signals to the despreader 110. The despreader 110 despreads the I and Q channel signals using the PN codes generated from the PN code generator 105, and outputs the despread I channel signal to a first offset compensator 115 and the despread Q channel signal to a second offset compensator 116. The first offset compensator 115 eliminates a negative offset component from the I channel signal that was generated from the despreader 110. That is, if 6-bit I and Q channel signals having a 2's complement data format are received, the first offset compensator 115 receives an input value ranging from −32 to +31, tending toward a negative value. Then the first offset compensator 115 compensates for an offset by multiplying the input value by ‘2’ and adding ‘1’ to the multiplied value, thereby outputting a value ranging from −63 to +63, and eliminating the negative offset component. The second offset compensator 116 performs substantially the same operation as the first offset compensator 115. That is, the second offset compensator 116 eliminates the negative offset component from the Q channel signal that was generated from the despreader 110. A first gain multiplier 120 multiplies the output of the first offset compensator 115 by a gain G in order to adjust the number of data bits applied to a peak detector 150, varying with the numbers of synchronous and asynchronous accumulations. A first synchronous accumulator 125 performs synchronous accumulations on the output signal of the first gain multiplier 120 during a synchronous accumulation period for minimizing the effect of a frequency offset. The synchronous accumulation period is loaded by a controller (not shown). Similarly, a second gain multiplier 121 multiplies the output signal of the second offset compensator 116 by the gain G. A second synchronous accumulator 126 performs synchronous accumulations on the output signal of the second gain multiplier 121.

First and second squarers 135 and 136 in an energy calculator 130 square the synchronously accumulated I and Q channel data output from the first and second synchronous accumulators 125 and 126, respectively. A summer 140 sums up the squared results of the synchronously accumulated I and Q channel data channel signals that were generated from the first and second squarers 135 and 136 to calculate an energy value. An asynchronous accumulator 145 accumulates the energy value generated from the summer 140 as many times as the number of asynchronous accumulations occur during an asynchronous accumulation period loaded by the controller. The peak detector 150 detects a peak value among the asynchronously accumulated values and an index at the peak value. The index at the peak value is an offset with the PN codes generated in synchronization with an absolute time and the UE can complete synchronization acquisition with a corresponding Node B by using the offset.

FIG. 2 is a block diagram illustrating an internal structure of a general PN code generator, especially, a PN code generator having a polynomial of X³+X²+1. Referring to FIG. 2, PN codes used in the CDMA system have periodicity and the properties of an auto-correlation function. In other words, the auto-correlation function is characterized by a correlation value approximating to ‘0’ when the synchronization is not accurately acquired even if it has a sequence such as one PN output. The correlation value between two PN codes with different sequences is always ‘0’ showing the properties of a cross-correlation function.

The PN code generator basically includes feedback shift registers and a modulo-2 adder. Referring to FIG. 2, output values of 3 shift registers 201 to 203 and a specific register 204 are added in the modulo-2 adder 205. The output value of the modulo-2 adder 205 is fed back to the first shift register 201 to generate another code. Linearity of the PN code is determined by selection of a feedback tap. That is, the linearity of the PN code refers to a characteristic that a code with the same period is generated irrespective of an initial value of the shift register in a state that the feedback tap is determined. On the contrary, non-linearity of the PN code means that a code having a different period is generated according to the initial value of the shift register even if the feedback tap is determined. A typical characteristic among various characteristics of the linear code is that the period of the PN code is determined by the number of given registers. For example, if the number of registers is n, the PN code generated has the maximum length of 2ⁿ−1. In FIG. 2, the PN generator is filled with an initial value, and this is referred to as a “seed”. The standard seed value of the PN generator is ‘1’ for the most significant bit, and ‘0’ for the other bits, generating ‘100’. Therefore, the PN generator repeatedly generates ‘1001011’.

FIG. 3 is a block diagram illustrating an internal structure of a masked PN code generator. Referring to FIG. 3, the masked PN code generator includes shift registers 201 to 203 described in conjunction with FIG. 2 and a PN mask. A mask code value is ‘011’ as illustrated by registers 304, 306 and 307. The mask code value and the values of the shift register 201 to 203 are logically ANDed using AND gates 301, 302 and 303 and the logically ANDed results are added in a modulo-2 adder 305. A PN mask code of ‘0111001’ is repeatedly generated as the masked output 308. The PN mask code of ‘0111001’ has an offset by 4 compared with the PN code generated in the PN code generator of FIG. 2. In this manner, the PN code having a difference from the unmasked code by a prescribed offset can be generated by modifying the mask code value.

FIG. 4 is a block diagram illustrating an internal structure of a short PN code generator in the CDMA mobile communication system. Referring to FIG. 4, a short PN code is generated by 15 shift registers labeled 0 to 14. Generally, the short PN code is used for spread spectrum in the CDMA mobile communication system. The spread spectrum is performed by Quadrature Phase Shift Keying (QPSK) modulation on a data signal and the short PN code. The short PN code for an I channel and the short PN code for a Q channel are used for the QPSK modulation. The PN code used in the CDMA mobile communication system differs in an equation according to the setting position of a feedback tap. A masked PN code generator of the short PN code generator shown in FIG. 4 uses a polynomial P_{I}(x)=x¹⁵+x¹³+x⁹+x⁸+x⁷+x⁵+1 and a polynomial P_{Q}(x)=x¹⁵+x¹³+x¹¹+x¹⁰+x⁶+x⁵+x⁴+x³+1.

Codes PN_I_MASK and PN_Q_MASK shown in FIG. 4 have the properties of the auto-correlation function with the existing PN code in order to generate a new PN mask code. A period 2ⁿ−1 of the short PN code generator is not identical to a reference time period of even seconds in the synchronous system. Therefore, one chip is forcefully inserted by zero inserters 411 and 413 each time the period of the PN code is ended. Thus the short PN code is accurately repeated 75 times every 2 seconds. Therefore, a start point of the short PN code can be precisely known only with even-second information. The even-second information is given to all Node Bs through a Global Positioning System (GPS).

FIG. 5 is a block diagram illustrating an internal structure of a general scrambling code generator in the asynchronous mobile communication system. The scrambling code generator of FIG. 5 uses polynomials of x sequence=x¹⁸+x⁷+1 and y sequence=x¹⁷+x¹⁰+x⁷+x⁵+1.

Referring to FIG. 5, the scrambling code is used as a cell specific code to identify a cell in the asynchronous system. In the asynchronous system, synchronization is acquired using the 3-step cell search algorithm described above. The third-step cell search process is a cell search process for searching a code of a current cell among 8 codes within a cell code group based on information about the frame synchronization and the current cell group searched in the second-step cell search process. Meanwhile, the scrambling code generator uses a Gold sequence obtained by position-wise modulo-2 sum for 38400 chips of two binary m-sequences. In this case, a code of an imaginary part is a cyclic shifted version of 131,072 chips of a real part. Since the scrambling code generator has a structure similar to the above-described PN code generator, a detailed description thereof will not be given herein.

A UE, which is a mobile communication terminal, is characterized by its mobility and portability. To provide the mobility and portability of the mobile communication terminal, a battery is used as a power source. A method for increasing a standby time of the battery has been studied. To increase the standby time of the battery, the power consumed in internal elements of the mobile communication terminal needs to be minimized. The main factors contributing to the power consumption of the mobile communication terminal include power consumption caused by sleep current, a digital part, and a radio frequency (RF) part. The sleep current results in power consumption while a message is not being received and includes current consumed in, for example, an oscillator, an Liquid Crystal Display (LCD), a microprocessor, and a power supply. During power consumption caused by the sleep current, the highest power is consumed by the oscillator. Therefore, the power consumption of the oscillator, especially, an RF oscillator should be decreased. In order to reduce the power consumption caused by the RF part, a time during which a power is provided to a receiver of the RF part, that is, a time during which the RF part is in an “ON” state should be minimized. For this to occur, in the IMT-2000 system, a paging message is received only at a specific slot uniquely assigned to each mobile communication terminal, thereby reducing the power consumption during standby. However, even though the slot is uniquely assigned to each mobile communication terminal, unnecessary messages may be transmitted, and it is not easy to ensure a sufficient standby time in consideration of synchronization reacquisition and message reception ready time prior to the slot being assigned to receive the paging message. To solve such problems, quick paging has been introduced. Quick paging is a scheme for informing the mobile communication terminal whether a paging/control message exists at the slot assigned through a new physical channel in addition to a current paging channel. Meanwhile, a search process for the quick paging is performed on-line wherein an intact signal received through an antenna is processed if there is a sufficient search time, or off-line wherein a signal received through an antenna is stored in a buffer and then processed by an operating command in order to reduce the power consumption if there is insufficient search time or during a sleep mode. To accomplish quick paging, two PN code generators are used to identify on-line and off-line transactions.

As described above, the 3^{rd} generation mobile communication system, i.e., IMT-2000 system has to use additional synchronization acquisition hardware, especially, an additional code generator according to each system mode, and should be equipped with an additional PN code generator for supporting the quick paging scheme in order to reduce the power consumption. However, a simple combination of synchronization acquisition hardware devices for supporting various system modes and the quick paging scheme brings about an increase in hardware size and cost. Therefore, it is necessary to acquire the synchronization using a simple hardware structure.

### SUMMARY OF THE INVENTION

It is, therefore, an object of the present invention to provide an apparatus and method for synchronization acquisition in a mobile communication system.

It is another object of the present invention to provide a synchronization acquisition apparatus which can acquire synchronization in both a synchronous scheme and an asynchronous scheme through a code generator for generating a code for a corresponding system mode and its controller in a mobile communication system.

an apparatus for synchronization acquisition in a user equipment (UE) communicating with any one of a first Node B of a first system mode operating in a synchronous scheme and a second Node B of a second system mode operating in an asynchronous scheme in a mobile communication system. The apparatus includes a controller for determining a system mode of a current Node B to which the UE belongs and generating a system mode select signal for selecting the determined system mode, and a code generator for generating a synchronization code used in the first system mode or the second system mode in response to the system mode select signal.

a method for synchronization acquisition in a user equipment (UE) communicating with any one of a first Node B of a first system mode operating in a synchronous scheme and a second Node B of a second system mode operating in an asynchronous scheme in a mobile communication system. The method includes the steps of determining a system mode of a current Node B to which the UE belongs, and generating a synchronization code used in the first system mode or the second system mode according to the determined system mode.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram illustrating a general synchronization acquisition apparatus of a CDMA mobile communication system;

FIG. 2 is a block diagram illustrating an internal structure of a general PN code generator;

FIG. 3 is a block diagram illustrating an internal structure of a general masked PN code generator;

FIG. 4 is a block diagram illustrating an internal structure of a general short PN code generator in a synchronous mobile communication system;

FIG. 5 is a block diagram illustrating an internal structure of a general scrambling code generator in an asynchronous mobile communication system;

FIG. 6 is a block diagram illustrating a synchronization acquisition apparatus according to an embodiment of the present invention;

FIG. 7 illustrates symbol patterns applied to a common pilot channel of an asynchronous mobile communication system according to an embodiment of the present invention;

FIG. 8 is a block diagram illustrating a common pilot channel symbol pattern generator of an asynchronous mobile communication system according to an embodiment of the present invention;

FIG. 9 is a block diagram illustrating an internal structure of the PN code generator shown in FIG. 6 according to an embodiment of the present invention;

FIG. 10A is a block diagram illustrating an internal structure of the first feedback controller shown in FIG. 9 according to an embodiment of the present invention; and

FIG. 10B is a block diagram illustrating an internal structure of the second feedback controller shown in FIG. 9 according to an embodiment of the present invention.

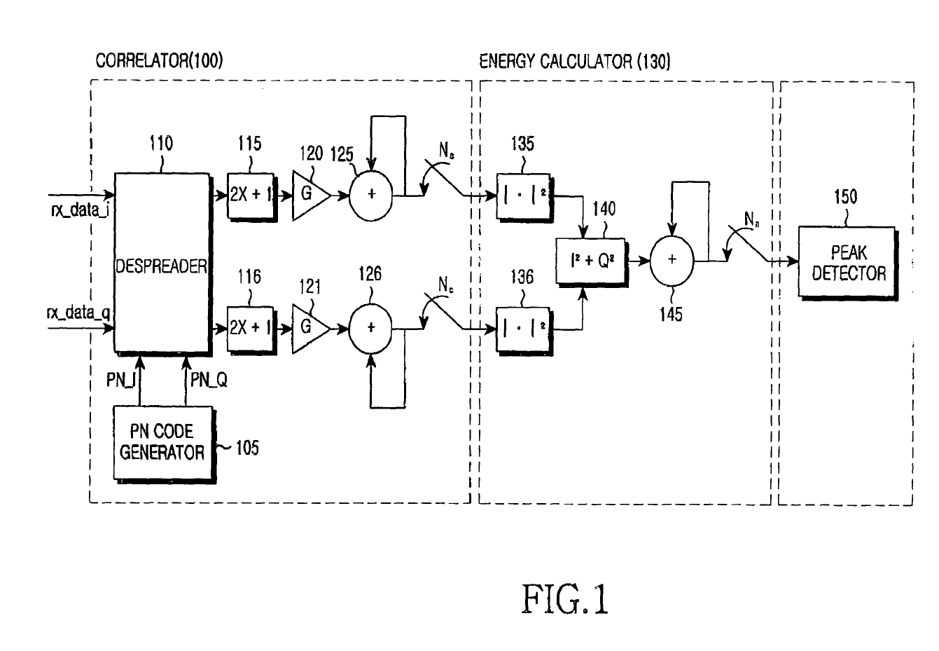

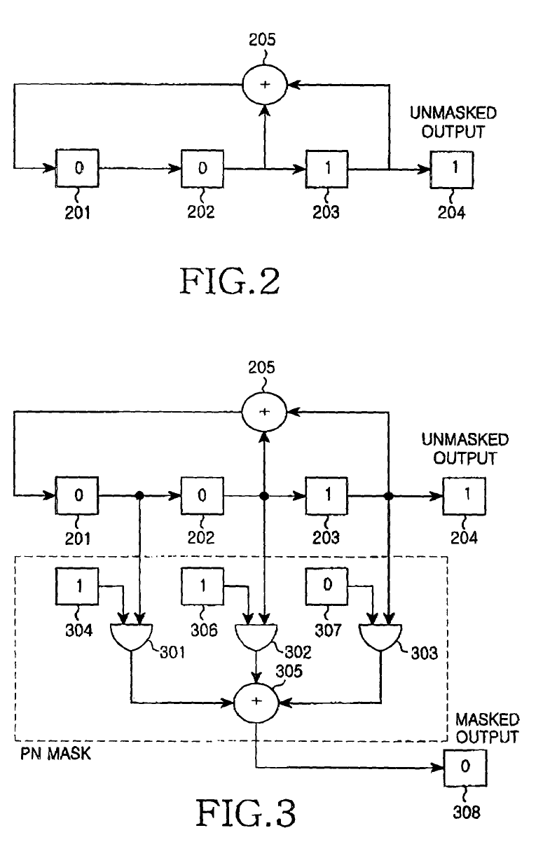

### DETAILED DESCRIPTION OF THE PREFERRED EMBODIMENT

Several embodiments of the present invention will now be described in detail with reference to the accompanying drawings. In the drawings, the same or similar elements are denoted by the same reference numerals. Also, a detailed description of known functions and configurations have been omitted for conciseness.

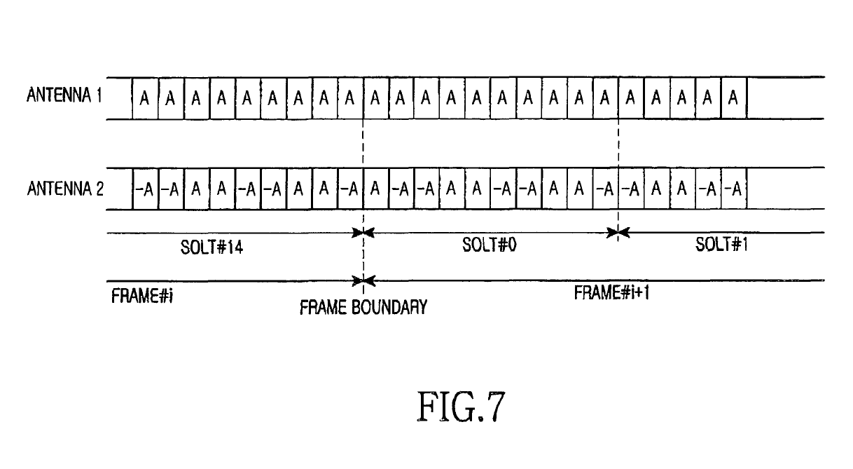

FIG. 6 is a block diagram illustrating an internal structure of a synchronization acquisition apparatus according to an embodiment of the present invention. Referring to FIG. 6, an IMT-2000 system, which is a 3^{rd} mobile communication system, can have various system modes as depicted in conjunction with the prior art. The IMT-2000 system can differ in the number of bits of digitally converted I/Q channel signals applied to the synchronization acquisition apparatus or differ in the codes being generated from a code generator according to the system modes. Therefore, if a UE receives I/Q channel signals from a Node B, a controller 601, which is illustrated in FIG. 6 determines a system mode of the Node B. The controller 601 then generates a system mode select signal according to the determined system mode of the Node B and controls the synchronization acquisition apparatus according to the system mode of the Node B.

A method for selecting the system mode by the controller 601 will be described below on the assumption that there are two systems, that is, a CDMA 2000 system (hereinafter, referred to as the “synchronous system”) and an UMTS system (hereinafter, referred to as the “asynchronous system”).

The controller 601 stores a mode of a system to which a UE belongs just before the UE powers-off. If the UE is powered on, the controller 601 detects the system mode before the UE powers-off and generates a system mode select signal for selecting the detected system mode, thereby enabling the synchronization acquisition apparatus to perform a synchronization acquisition procedure corresponding to the system mode select signal. As a result of the synchronization acquisition procedure, if a current system, i.e., the system to which the UE currently belongs, is not identical to a previous system, i.e., the system to which the UE belonged prior to the UE powering-off. The controller 601 generates another system mode select signal for selecting another system mode, thereby enabling the synchronization acquisition apparatus to perform the synchronization acquisition procedure corresponding to the system mode select signal.

While a control method for sequentially acquiring synchronization of the current system from the previous system has been described, another method for selecting the system mode by the controller 601 will be described below.

If the UE is powered on, the controller 601 first generates a system mode select signal corresponding to a specific system set by a service provider, so that the synchronization acquisition apparatus can perform the synchronization acquisition procedure corresponding to the system mode select signal. As a result of the synchronization acquisition procedure, if the current system is not identical to the system corresponding to the system mode select signal, the controllers 601 generates a system mode select signal for selecting a system other than the initially set system, so that the synchronization acquisition apparatus can implement the synchronization acquisition procedure corresponding to the system select mode signal.

Another method for selecting the system mode is provided. Upon powering-on of the UE, the controller 601 can generate the system mode select signal in stored order in a memory of the UE.

In a handover situation, the controller 601 generates the system mode select signal in the following manner. The UE can manage information on neighbor cells by constantly searching the state of the neighbor cells. A compressed mode technique has been introduced as neighbor cells information managing method for implementing handover between cells using different systems. Therefore, even though the UE travels to another cell using a different system, the controller 601 can generate the system mode select signal by previously judging the system mode of a corresponding cell.

Though the above system mode selecting methods by the controller 601 have been described by way of example, it will be apparent that various methods for selecting the system mode can be used. In the following description, it is assumed that the synchronous system or the CDMA 2000 system is set to ‘0’ and the asynchronous system or the UMTS is set to ‘1’, as the system mode select signal generated from the controller 601.

A PN code generator 630 generates PN codes to be applied to a corresponding system in response to the system mode select signal output from the controller 601. For instance, if the system mode select signal is ‘1’, the PN code generator 630 generates PN codes corresponding to scrambling codes of the asynchronous system. A despreader 611 despreads received data, that is, an I channel signal rx_data_i and a Q channel signal rx_data_q with the codes generated from the PN code generator 630. The codes generated from the PN code generator 630 are input to first and second multipliers 602 and 603 and to first and second multiplexers 604 and 605. The first and second multipliers 602 and 603 and the first and second multiplexers 604 and 605 are used when transmit diversity such as time diversity or space diversity is applied. If the transmit diversity is not applied, the first and second multipliers 602 and 603 and the first and second multiplexers 604 and 605 do not implement an additional operation.

In operation, when the Node B of the asynchronous system to which the UE currently belongs uses the transmit antenna diversity, the controller 601 enables the first and second multipliers 602 and 603 in order to restore signals transmitted through a plurality of antennas from the Node B, i.e., the specific patterns of two antenna signals, by multiplying a specific pattern e.g., S-pattern, by the codes generated from the PN code generator 630. The first multiplexer 604 multiplexes an I channel PN code PN_I generated from the PN code generator 630 and a signal generated from the first multiplier 602. The second multiplexer 605 multiplexes a Q channel PN code PN_Q generated from the PN code generator 630 and a signal generated from the second multiplier 603. The output signals of the first and second multiplexers 604 and 605 are input to the despreader 611.

The despreader 611 outputs the despread I channel signal to a first offset compensator 613 and the despread Q channel signal to a second offset compensator 623. The first offset compensator 613 eliminates a negative offset component from the I channel signal generated from the despreader 611. That is, if 6-bit I and Q channel signals having a 2's complement data format are received, the first offset compensator 613 receives input values ranging from −32 to +31, tending toward a negative value. Then the first offset compensator 613 compensates for an offset by multiplying the input value by ‘2’ and adding ‘1’ to the multiplied value, thereby outputting a value ranging from −63 to +63. This eliminates the negative offset component. A first gain multiplier 615 multiplies the output signal of the first offset compensator 613 by a gain G in order to adjust the number of data bits applied to a peak detector 650, varying with the number of synchronous and asynchronous accumulations. Similarly, the second offset compensator 623 eliminates the negative offset component from the Q channel signal generated from the despreader 611. The second gain multiplier 625 multiplies the output signal of the second offset compensator 623 by a gain G.

A first synchronous accumulator 617 performs synchronous accumulations as many times as the number Nc of synchronous accumulations determined by the controller 601 occur during a synchronous accumulation period for minimizing the effect of a frequency offset. The synchronous accumulation period is provided by the controller 601 as a parameter. A second synchronous accumulator 627 receives the output signal of the second gain multiplier 625 and performs synchronous accumulations as many times as the number Nc of the synchronous accumulations occur. First and second squarers 631 and 633 in an energy calculator 640 square the synchronously accumulated I and Q channel signals generated from the first and second synchronous accumulators 617 and 627, respectively, and provides the squared results to a summer 635. The summer 635 sums up the squared results of the synchronously accumulated I and Q channel signals in order to calculate the energy. An asynchronous accumulator 637 accumulates the output signal of the summer 634 as many times as the number Nn of asynchronous accumulations occur. The number of the asynchronous accumulations is provided as a parameter by the controller 601. The peak detector 650 selects a peak value among the asynchronously accumulated values during a period which is expected to output the peak value and complete synchronization acquisition at a peak value detected point. Namely, a correlation process is performed during a period e.g., the number Nc of the synchronous accumulations x the number Nn of the asynchronous accumulations. The peak detector 650 detects the peak value among the input values and an index at the peak value. The index at the peak value is a scrambling code transmitted from the cell in order to acquire synchronization among 8 scrambling codes within a cell code group. The UE can complete synchronization acquisition with the cell by using the scrambling code.

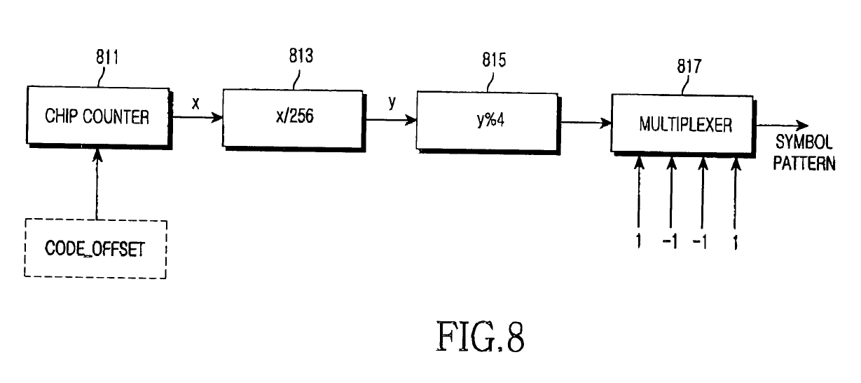

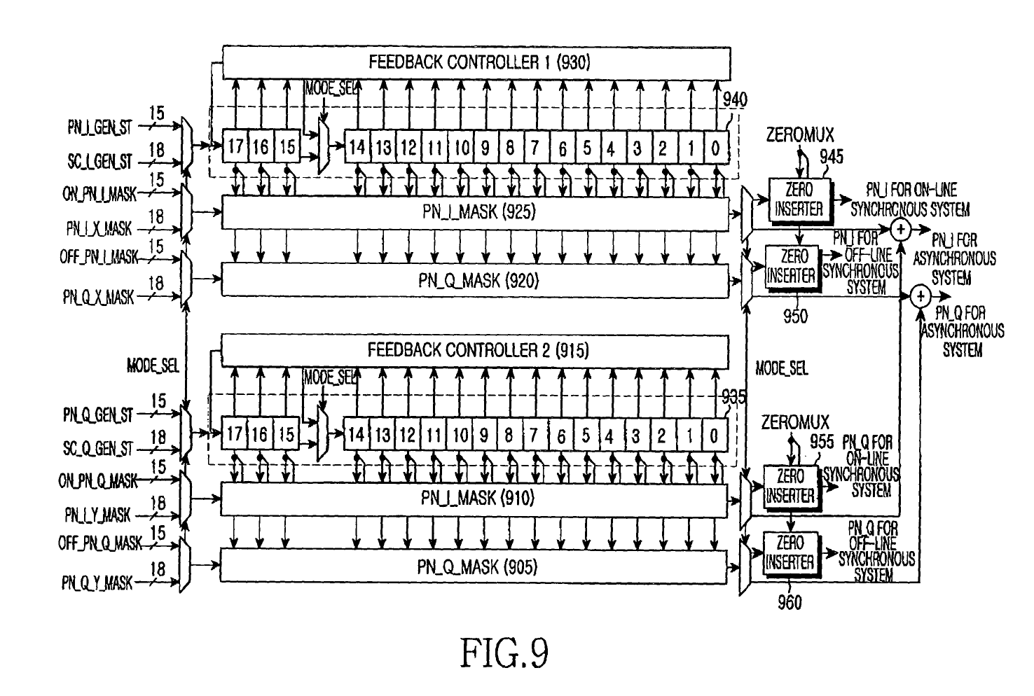

Meanwhile, the asynchronous system provides transmit diversity using two antennas as described above. Of the two antennas, a first antenna transmits an original transmission signal and a second antenna transmits a signal obtained by multiplying the specific pattern S-pattern by the transmission signal transmitted through the first antenna, thereby obtaining a diversity effect at a receiving side which will be described with reference to FIGS. 7 and 8.

FIG. 7 illustrates symbol patterns applied to a CPICH of the asynchronous system according to an embodiment of the present invention. Referring to FIG. 7, a symbol pattern applied to the CPICH differs based on an antenna. The symbol patterns respectively applied to first and second antennas are shown in FIG. 7. Referring to FIG. 7, on the basis of a frame boundary, while a first antenna signal A A A A is transmitted through the first antenna, a second antenna signal A −A −A A obtained by multiplying the first antenna signal by the specific pattern S-pattern e.g., 1 −1 −1 1, is transmitted through the second antenna. Therefore, the first and second multipliers 602 and 603 respectively multiply, as depicted with reference to FIG. 6, the I channel PN code PN_I and the Q channel PN code PN_Q using the specific pattern, e.g., an S-pattern, to provide a space diversity gain.

FIG. 8 is a block diagram illustrating a CPICH symbol pattern generator for generating the symbol patterns shown in FIG. 7 according to an embodiment of the present invention. Referring to FIG. 8, the symbol pattern generator of the asynchronous system operates in synchronization with a scrambling code generator of the asynchronous system, that is, the PN code generator 630. A chip counter 811 receives the current state of the PN code generator 630 as a register value CODE_OFFSET, adjusts synchronization with the scrambling code generated from the PN code generator 630, and counts chips at a 38400-chip period, e.g., a scrambling code period. A divider (×/256) 813 divides a count value x counted by the chip counter 811 by 256. A quotient y of the count value x divided by 256 is applied to a modulo-4 operator 815 and the output signal of the modulo-4 operator 815 passes through a multiplexer 817 for selecting a value [1, −1, −1, 1], thereby generating the specific pattern S-pattern. For example, if the count value x is 2560, then the quotient y is 10 and the result of the modulo-4 operation becomes 0. Therefore, the multiplexer 817 selects the symbol pattern of 1. If the count value x is 2561, a symbol pattern of −1 is generated through the above process.

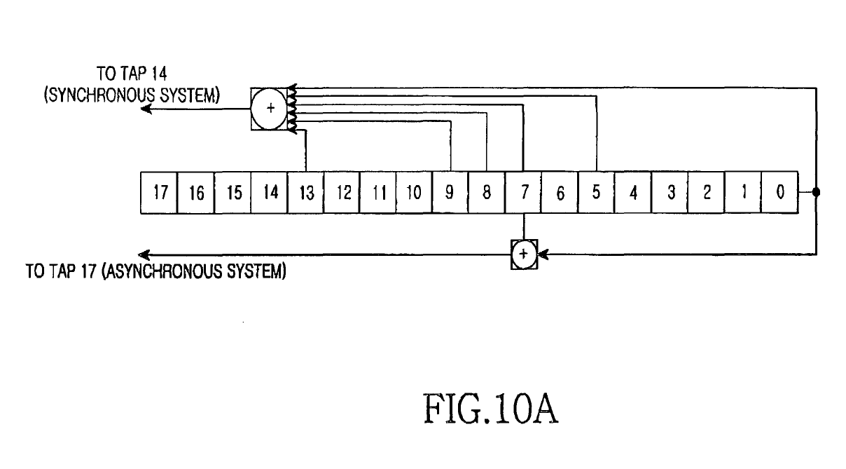

FIG. 9 is a block diagram illustrating an internal structure of the PN code generator 630 shown in FIG. 6 according to an embodiment of the present invention. For simplicity of description, it is assumed that bit widths of signals input through an analog/digital converter is identical to each other in both the synchronous system and the asynchronous system As described in conjunction with FIG. 6, the controller 601 determines the system mode of the current cell, generates the system mode select signal MODE_SEL corresponding to the determined system mode, and provides the system mode select signal MODE_SEL to the PN code generator 630 of the synchronization acquisition apparatus.

If the system mode select signal of ‘1’, which indicates that the cell to which the UE currently belongs is an asynchronous system, is provided, the controller 601 loads into the PN code generator 630 corresponding values for the synchronization acquisition, such as associated asynchronous register values PN_I_X_MASK, PN_I_Y_MASK, PN_Q_X_MASK and PN_Q_Y_MASK, values SC_I_GEN_ST and SC_Q_GEN_ST for designating the initial state of x-sequence shift registers 935 and 940, a transmit diversity signal td_mode, the number Nc of synchronous accumulations, and the number Nn of asynchronous accumulations. Since the number of taps of the scrambling code in the UMTS system is 18, the first and second feedback controllers 930 and 915 control a feedback tap to automatically feed the feedback tap back to a tap 17 when the system mode select signal is set to ‘1’. Contrarily, since the number of taps of the short PN code in the synchronous system is 15, the first and second feedback controllers 930 and 915 control the feedback tap to automatically feed the feedback tap back to a tap 14 when the system mode select signal is set to ‘0’.

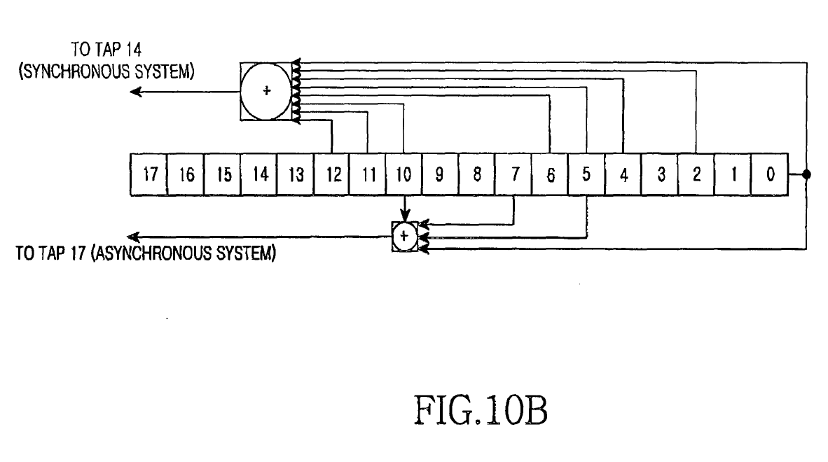

FIGS. 10A and 10B are block diagrams illustrating internal structures of the first and second feedback controllers 930 and 915 shown in FIG. 9. As illustrated in FIGS. 10A and 10B, respective taps of the first and second feedback controllers 930 and 915 are fed back. Since the feedback structure of the tap is well known, a detailed description thereof will not be given herein.

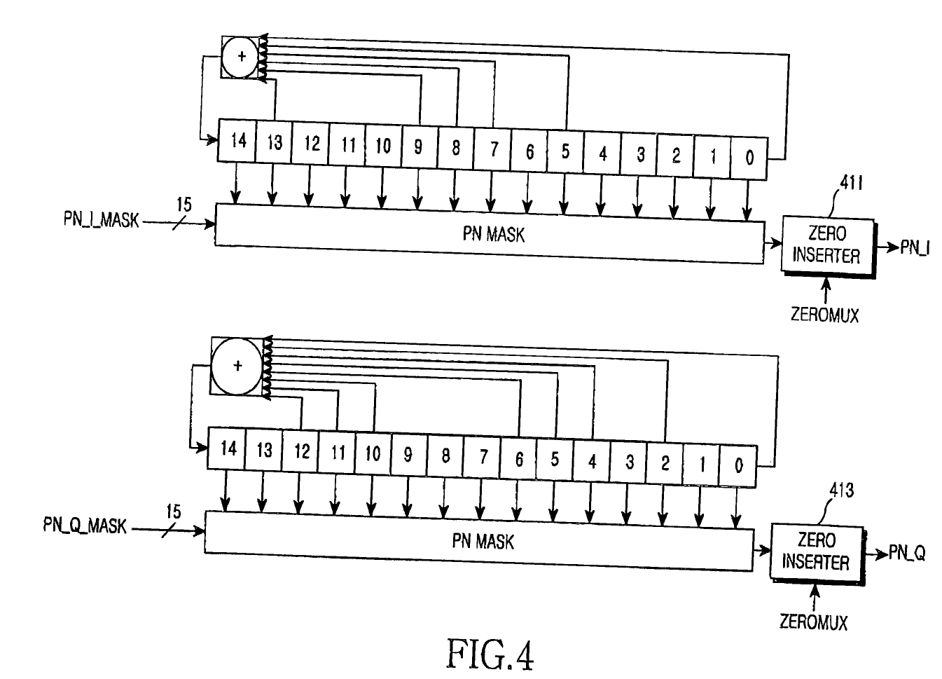

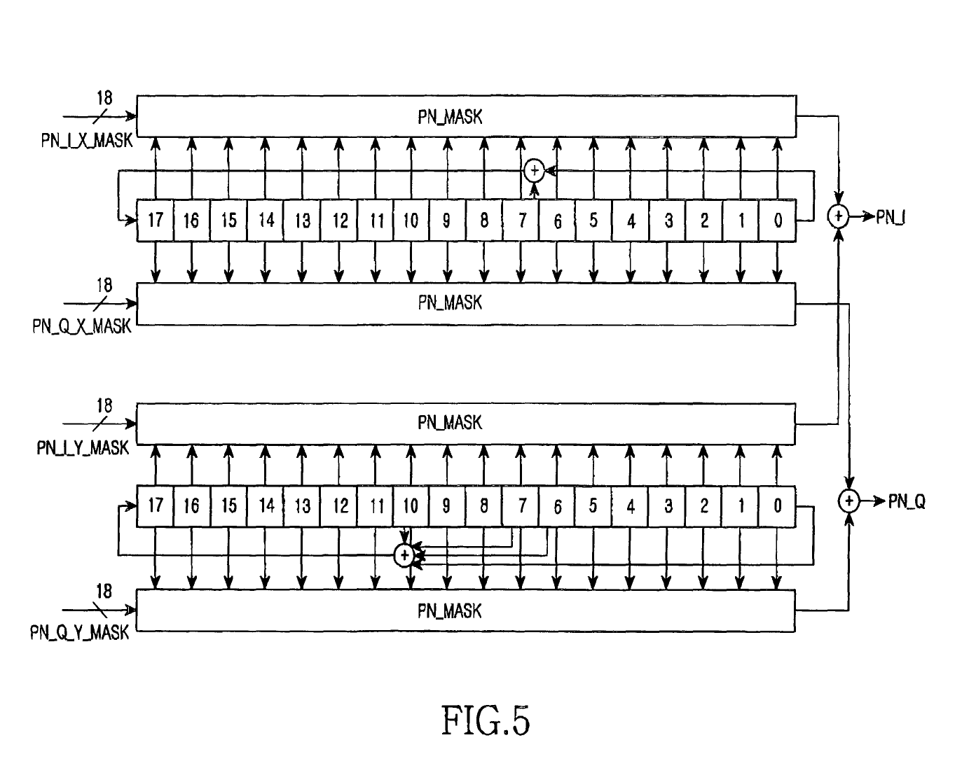

If the system mode select signal of ‘1’ is provided to the PN code generator 630, the I channel PN code PN_I of the asynchronous system is generated by performing a logical exclusive OR operation on a logically AND operated result, as shown in FIG. 3, between each bit set to the value PN_I_X_MASK in a first I channel mask PN_I_MASK 925 and each bit output of the shift register 940 having the value SC_I_GEN_ST as an initial value and a logically AND operated result between each bit set to the value PN_I_Y_MASK in a second I channel mask PN_I_MASK 910 and each bit output of the shift register 935 having the value SC_Q_GEN_ST as an initial value. The Q channel PN code PN_Q of the UTMS system is generated by performing a logical exclusive OR operation on a logically AND operated result, as shown in FIG. 3, between each bit set to the value PN_Q_X_MASK in a first Q channel mask PN_Q_MASK 920 and each bit output of the shift register 940 having the value SC_I_GEN_ST as an initial value and an ANDed result between each bit set to the value PN_Q_Y_MASK in a second Q channel mask PN_Q_MASK 905 and each bit output of the shift register 935 having the value SC_Q_GEN_ST as an initial value.

If the system mode select signal of ‘0’ is provided to the PN code generator 630, the PN code for the synchronous system is generated. The registers related to the synchronization acquisition of the synchronous system are set to automatically operate when the system mode select signal is set to ‘0’. Therefore, values ON_PN_I_MASK, OFF_PN_I_MASK, ON_PN_Q_MASK and OFF_PN_Q_MASK, and values PN_I_GEN_ST and PN_Q_GEN_ST for designating the initial state of the shift registers 935 and 940 to generate the PN mask code are provided from the controller 601. A search method for the synchronous system is divided into an on-line search method for searching reception data of an antenna in real time and an off-line search method for searching reception data at a permitted time after a buffering operation, and they employ separate PN code generators.

The I channel PN code PN_I used in an on-line synchronous system is generated by inserting ‘0’ through a zero inserter 945 at an end of every period into a logically AND operated result, as shown in FIG. 3, between each bit set to the value ON_PN_I_MASK in the mask PN_I_MASK 925 and each bit output of the shift register 940 having the value PN_I_GEN_ST as an initial value. The Q channel PN code PN_Q used in an on-line CDMA system is generated by inserting ‘0’ through a zero inserter 955 at an end of every period into a logically AND operated result, as shown in FIG. 3, between each bit set to the value ON_PN_Q_MASK in the mask PN_Q_MASK 905 and each bit output of the shift register 935 having the value PN_Q_GEN_ST as an initial value. The I channel PN code PN_I used in an off-line synchronous system is generated by inserting ‘0’ through a zero inserter 950 at an end of every period into a logically AND operated result, as shown in FIG. 3, between each bit set to the value OFF_PN_I_MASK in the mask PN_I_MASK 925 and each bit output of the shift register 940 having the value PN_I_GEN_ST as an initial value. The Q channel PN code PN_Q used in an off-line CDMA system is generated by inserting ‘0’ through a zero inserter 960 at an end of every period into a logically AND operated result, as shown in FIG. 3, between each bit set to the value OFF_PN_Q_MASK in the mask PN_Q_MASK 905 and each bit output of the shift register 935 having the value PN_Q_GEN_ST as an initial value.

That is, the PN codes PN_I and PN_Q for the off-line synchronous system are generated through the same process as those for the on-line synchronous system, but the initial values of the shift registers use PN state values at a buffering start point of the reception data.

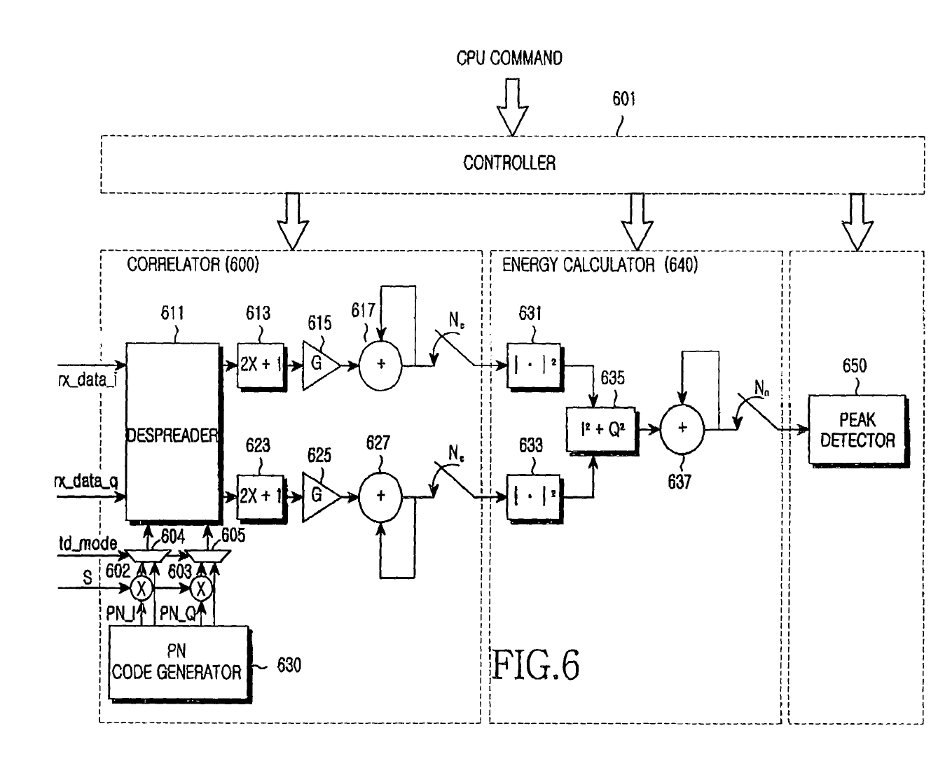

The short PN code generator in the synchronization acquisition process of the synchronous system has a period of 2ⁿ−1 as described with reference to FIG. 5. However, this period is not accurately equal to a reference time period of even seconds. Therefore, the zero inserters 945, 950, 955 and 960 forcefully insert one chip of a value ‘0’ at end of every period of the PN code. Namely, by making minor modifications to the structure, the short PN code is repeated 75 times every 2 seconds. Thus the start point of the PN code can be accurately known only with even-second information.

As described above, the synchronization acquisition in various system modes such as asynchronous and synchronous modes in the mobile communication system is achieved by using one hardware apparatus. Furthermore, on-line synchronization acquisition and off-line synchronization acquisition in the synchronous system can be accomplished through the use of one code generator. This contributes to a reduction in hardware size and cost.

While the invention has been shown and described with reference to a certain embodiment thereof, it will be understood by those skilled in the art that various changes in form and details may be made therein without departing from the spirit and scope of the invention as defined by the appended claims.

1. An apparatus for synchronization acquisition in a User Equipment (UE) communicating with any one of a first Node B in a first system mode operating in a synchronous scheme and a second Node B in a second system mode operating in an asynchronous scheme in a mobile communication system, comprising:
a controller for determining a system mode of a current Node B to which the UE belongs and generating a system mode select signal in order to select the determined system mode; and
a code generator for generating a synchronization code used in the first system mode or the second system mode in response to the system mode select signal.

2. The apparatus of claim 1, wherein the controller determines a system mode of a previous Node B to which the UE belongs prior to the UE powering-off as the system mode of a current Node B.

3. The apparatus of claim 1, wherein the controller determines a system mode of a Node B, which was set by a service provider of the mobile communication system, as the system mode of a current Node B.

4. The apparatus of claim 1, wherein the controller determines a system mode having a first priority among system modes previously stored in the UE as the system mode of a current Node B.

5. The apparatus of claim 1, wherein the code generator comprises:
a register unit having a second number of registers necessary for generating a synchronization code used in the second system mode, the register unit operating so that a feedback value is input to a first number of shift registers necessary for generating a synchronization code used in the first system mode or to a second number of shift registers necessary for generating a synchronization code used in the second system mode, according to a predetermined control generated by the system mode select signal;
a synchronization code mask unit for masking a mask value for generating the synchronization code used in the first system mode or the synchronization code used in the second system mode, to a shift register value according to a predetermined control; and
a feedback controller for determining a register feedback tap of the register unit for generating the synchronization code used in the first system mode or the synchronization code used in the second system mode according to a predetermined control generated by the system mode select signal, and inputting a feedback value to a shift register corresponding to a system mode.

6. A method for synchronization acquisition in a user equipment (UE) communicating with any one of a first Node B in a first system mode operating in a synchronous scheme and a second Node B in a second system mode operating in an asynchronous scheme in a mobile communication system, comprising the steps of:
determining a system mode of a current Node B to which the UE belongs; and
generating a synchronization code used in the first system mode or the second system mode according to the determined system mode.

7. The method of claim 6, wherein the determining step determines a system mode of a Node B to which the UE belongs prior to the UE powering-off as the system mode of a current Node B.

8. The method of claim 6, wherein the determining step determines a system mode of a Node B, which was set by a service provider of the mobile communication system, as the system mode of a current Node B.

9. The method of claim 6, wherein the determining step determines a system mode having a first priority among system modes previously stored in the UE as the system mode of a current Node B.

10. The method of claim 6, wherein the synchronization code generating step comprises the steps of:
receiving a mask value and a shift register value for generating a synchronization code used in the first system mode or a synchronization code used in the second system mode according to the system mode select signal;
determining a register feedback tap for generating the synchronization code used in the first system mode or the synchronization code used in the second system mode according to the determined system mode, and inputting a feedback value to a shift register corresponding to a system mode;
shifting register values so that a feedback value is input to a first number of shift registers necessary for generating the synchronization code used in the first system mode or to a second number of shift registers necessary for generating the synchronization code used in the second system mode according to the determnined system mode; and
generating a synchronization code by masking a mask value for generating the synchronization code used in the first system mode or the synchronization code used in the second system mode, to the shift register value according to the determined system mode.
